(19) United States
(12) Patent Application Publication
(10) Pub. No.: US 2007/0112520 A1
(43) Pub. Date: May 17, 2007

(54) Building structures monitoring system

(76) Inventor: Massimo Marrocco, Roma (IT)

Correspondence Address: YOUNG & THOMPSON, 745 SOUTH 23RD STREET, 2ND FLOOR, ARLINGTON, VA, 22202, US

(21) Appl. No.: 10/565,647

(22) PCT Filed: Aug. 1, 2003
(86) PCT No.: PCT/IT03/00492

§ 371 Date: Mar. 27, 2006

(51) Int. Cl. G06F 19/00

(52) U.S. Cl. 702/5

(57) ABSTRACT

System for monitoring the stability status of building structures made of steel, wood, reinforced concrete or other suitable material, including, in combination, a management and control station (C) thereto one or more seismic and/or vibrational sensors (S) of known type are connected, respectively calibrated on the band of the yielding characteristic frequencies peculiar to the bearing structure thereto they are fastened, and at least an acoustic and optical signaller (A) which is activated by the management station (C) itself in case the bearing structures be subjected to stresses so as to induce tensions considered dangerous; thus obtaining that, in case of danger, the present personnel could have the time for abandoning the structures which are going to collapse or for intervening if possible.

The present invention mainly relates to the building field and in particular to the safety concerning the stability of the structures.

The stability of the structures is not only determined by the integrity thereof, but also by the extent and above all by the type of stresses and loads thereto they are subjected.

In this regard, it is useful to remind that according to the method of construction technique, called of the “allowable stresses”, there is a direct proportionality between the applied loads and the tensions induced thereby. In this context the dangerous phenomenon is represented by the yielding, thereat the great, irreversible plastic deformations start, which end with the collapse of the structure.

A structure can thus be considered safe when the tension status is sufficiently away from the yielding step. Among the materials constituting the bearing structures of buildings—made of reinforced concrete, steel, masonry, mixed with wood or alloy components—the yielding phenomenon repeats with curves of the load/tensions diagram characteristic for each material.

Going more into details, it is known that the passage from the elastic phase to the plastic phase is characterized by a variation in the status of crystalline aggregation of the resistant materials with inner creeping of the adhesion surfaces—both for the raw materials and for the aggregates—with consequent irreversible deformations. Such phenomena are accompanied by the generation of seismic and acoustic perturbations which realize into a particular emission of vibratory waves with characteristic frequency and which can be univocally identified.

Based upon such introduction, the present invention aims at monitoring the bearing and resistant structures by means of a suitable device called “Selective Microphone” properly calibrated so as to discriminate only the above described seismic perturbatory phenomena and thus aimed at timely identifying tensional situations of the structures which could reduce the margin of static safety as corresponding to the starting of the yielding phenomena.

Such picking-up timeliness advantageously allows to implement the necessary countermeasures, being still possible to rely on the residual resistance given by the plastic deformation phase, although specific activities aimed at reducing immediately the stress status are not implemented.

It is then an object of the present invention to provide an apparatus able to constantly monitor the stability of building structures, by timely signalling the eventuality in which said bearing structures are subjected to stresses dangerous for the stability itself.

According to the present invention, this has been obtained by providing to apply to the structures to be controlled one or more seismic detectors, each of them being calibrated, respectively, on one of the yielding characteristic frequencies peculiar to the type of the material constituting the resistant structure. In this way the detectors can signal the presence of dangerous stresses well before the structure starts really to collapse, allowing to those who are inside or near thereof to go away or to intervene, if possible, to make the stresses' cause to stop.

A better understanding of the invention will occur with the following detailed description and by referring to the enclosed figures which illustrate a preferred embodiment, by way of example and not for limitative purpose.

In the drawings:

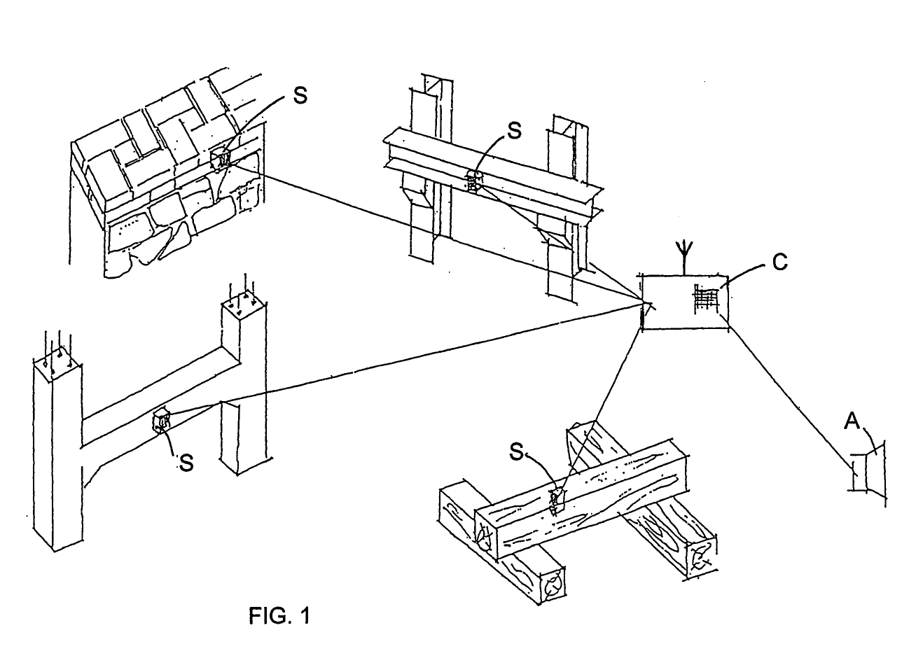

FIG. 1 schematically shows some types of bearing structures thereto it is possible to apply the invention.

By referring to FIG. 1, the invention provides a management and control station C thereto one or more selective and/or vibrational microphones S of know type are connected, respectively calibrated on one of the frequencies peculiar to the bearing structure whereon they are fastened, and at least an acoustic and optical signaller A which is activated by the management station C itself in case of danger in order to give the appropriate alarms to the present personnel to abandon the structure which are going to collapse or to intervene if possible.

According to the invention, the signals emitted by said vibrational sensors S are continuously monitored by the management station C, by means of a connection of known type, through wires or radio waves, in order to detect in real time the occurrence of phenomena which show the presence of structural stresses as from the initial phase thereof, during which the stresses have an extent so as not to set to zero the safety coefficient on allowable stresses, and therefore away from the destructive phase, but however detectable by means of appropriate seismic sensors.

Still according to the invention, the control station C can also be equipped with means for communicating with the outside or with a broader monitoring network which includes several building structures, as well as the main offices of firemen, hospitals, police and all those aid and/or security forces which have to intervene in case of emergency and danger for the safety of people or things.

It is useful to note that, in the building structures made of masonry, reinforced concrete, steel, wood, etc., there are background vibrations which are created by the traffic, wind, rain, which usually have very low frequencies, in the order of about 4 Hz.

The selective microphones, of known type, are mainly constituted by a picking-up source and by a suitable selection and filtration circuit so that the device, in reality, is sensible only and exclusively to a well-defined frequency band, as already described in the initial part, which band can be obtained by proper laboratory tests.

Both the single sensors S and the station C with the alarm signaller A can be powered by the supply mains and/or they can have their own battery which guarantees them to operate also in case of power failure.

Advantageously, the present invention is applicable to any type of bearing structure, in fact it is sufficient that the related sensor is calibrated on one of the frequencies peculiar to the structure to be controlled, apart from the fact that said structure is made of steel, wood, reinforced concrete or other.

Since in case of fire the bearing structures cede often due to high temperatures, a variant of the invention provides to equip the vibrational sensors S with thermo-protecting cases.

According to the invention, the implementation of a “field” version is also provided, properly reduced in sizes in order to be portable and equipped with power batteries and its own signalling and alarm devices, to be destined to the flying squads called for intervention in case of accidents however involving the bearing structures jeopardized by unforeseeable events and with collapse possibility independently from the existing loads, as in case of fires.

In case of a field device, it is preferable that it is equipped with means for adjusting the sensibility band, so as to allow the use thereof for different types of materials constituting the bearing structures.

According to the invention, it is further provided a second embodiment wherein the management and control station C receives from the sensors S a not filtered signal and the selection of the interesting band and the signal filtering take place inside the station itself by means of software or hardware processing.

Advantageously, in this variant of the invention the sensors S do not need any calibration and they mainly operate as simple microphones.

The present invention has been described and illustrated in a preferred embodiment thereof, but it is evident that any person skilled in the art could apply functionally equivalent modifications and/or replacements, without departing from the scope of the present industrial invention.

1-11. (canceled)

12. System for monitoring the stability status of building structures made of steel, wood, reinforced concrete or other suitable material, comprising, in combination, a management and control station (C) thereto one or more seismic and/or vibrational sensors (S) of known type are connected, and at least an acoustic and optical signaller (A) which is activated by the management station (C) itself in case said bearing structures are subjected to stresses so as to induce tensions considered dangerous, characterized in that said sensors (S) are respectively calibrated on the band of the yielding characteristic frequencies peculiar to the bearing structure thereon they are fastened and are suitable to signal the presence of dangerous stresses, well before the structure starts really to collapse; thus obtaining that, in case of danger, the present personnel could have the time for abandoning the structures which are going to collapse or for intervening if possible.

13. System according to claim 12, characterized in that the signals emitted by said vibrational sensors (S) are continuously monitored by the management station (C), by means of connections of known type through wires or radio waves, in order to detect in real time the occurrence of phenomena showing the presence of structural stresses as from the initial phase thereof, during which the tensions which generate the vibratory phenomena have an extent so as not to represent a danger, but however detectable by means of appropriate seismic sensors.

14. System according to claim 12, characterized in that the control station (C) is equipped with means for communicating with the outside and/or with a broader monitoring network including several building structures, as well as the main offices of firemen, hospitals, police and all those aid and/or security forces which have to intervene in case of emergency and danger for the safety of people or things.

15. System according to claim 12, characterized in that said seismic sensors (S) are constituted by inertia mechanical accelerometers and/or by piezodynamic sensors able to pick up even the oscillations of the structures and which have a known detection band.

16. System according to claim 12, characterized in that both the single sensors (S) and the station (C) with the alarm signaller (A), are powered by the supply mains and/or by their own battery which guarantees them to operate even in case of power failure.

17. System according to claim 12, characterized in that the vibrational sensors (S) are equipped with thermo-protective cases.

18. Portable device for monitoring the stability status of building structures made of steel, wood, reinforced concrete or other suitable material, comprising at least a seismic and/or vibrational sensor (S) of known type, equipped with means of known type for the calibration thereof, and at least an acoustic and optical signaller (A) which is activated by the sensor (S) itself in case the bearing structure itself is subjected to stresses so as to induce tensions considered dangerous characterized in that said calibration means are suitable to calibrate said sensors (S) on the band of the yielding characteristic frequencies peculiar to the material of the bearing structure whereon it has to be fastened; said device being equipped with power batteries.

19. Portable device according to claim 17, characterized in that it is equipped with a container protecting against the atmospheric agents, apt to protect it against high temperatures as well, for a time sufficient to give the alarm.

20. System for monitoring the stability status of building structures made of steel, wood, reinforced cement or other suitable material, comprising, in combination, a management and control station (C) which filters, analyzes and processes the signals received by one or more seismic and/or vibrational sensors (S) of known type, and at least an acoustic and optical signaller (A) which is activated by the management station (C) itself in case said bearing structures are subjected to stresses so as to induce tensions considered dangerous characterized in that the filtering, analyzing and processing performed by said control station (C) is intended for detect any signal from the sensors (S) which belongs to the band of the yielding characteristic frequencies peculiar to the bearing structure thereon the sensors (S) are fastened; thus obtaining that, in case of danger, the present personnel could have the time for abandoning the structures which are going to collapse or for intervening if possible.

21. System according to claim 20, characterized in that in said management and control station (C) the selection of the interesting band and the filtering of the signal received by the sensors (S) take place inside the station itself by means of software or hardware processing.

22. System according to claim 20, characterized in that the sensors (S) are simple microphones.

23. System according to claim 21, characterized in that the sensors (S) are simple microphones.
